(19) United States
(12) Patent Application Publication
(10) Pub. No.: US 2019/0047246 A1
(43) Pub. Date: Feb. 14, 2019

(54) HOT-MELT LAMINATED DECORATIVE LAMINATE

(71) Applicant: PROFOL KUNSTSTOFFE GMBH, Halfing (DE)

(72) Inventors: Helmut Bayer, Kienberg (DE); Josef Altenweger, Rosenheim (DE); Konrad Maier, Wasserburg (DE); Andrea Komorek, Untershofen, Söchtenau (DE)

(73) Assignee: PROFOL KUNSTSTOFFE GMBH, Halfing (DE)

(21) Appl. No.: 16/079,449

(22) PCT Filed: Feb. 24, 2017
(86) PCT No.: PCT/EP2017/054360

§ 371 Date: Aug. 23, 2018

(30) Foreign Application Priority Data
Feb. 24, 2016 (EP) 16157226.8

(51) Int. Cl. B32B 3/30; B32B 27/20; B32B 27/32; B32B 27/30; B32B 27/36; B32B 27/34; B32B 27/08; B32B 7/12; B32B 7/02; B32B 37/15; B32B 38/06

(52) U.S. Cl. CPC B32B 3/30; B32B 2309/105; B32B 27/32; B32B 27/308; B32B 27/302; B32B 27/36; B32B 27/34; B32B 27/08; B32B 7/12; B32B 7/02; B32B 37/153; B32B 38/06; B32B 2307/304; B32B 2307/102; B32B 2419/04; B32B 2451/00; B32B 2471/00; B32B 27/20

(57) ABSTRACT

The invention relates to a decorative laminate and methods of manufacturing thereof, in particular a structured decorative laminate, including at least the following immediately consecutive and mutually bonded layers A-B-C-D:
A: on the visible side, a functional layer comprising one or more ionomers and optionally one or more filler materials and/or functional additives dispersed in the layer;
B: an intermediate polymer layer comprising a mixture consisting of 5 to 95% by weight of extrudable ionomer, extrudable ionomer mixture or extrudable ionomer blend and 95 to 5% by weight of a polyolefin;
C: a tie layer comprising one or more modified plastics for the tie;
D: on the substrate side, a decorative layer;
   characterised in that the layered composite consisting of the layers A, B and C is coextruded and hot-melt laminated with the substrate-side decorative layer at a temperature above the fusion temperature of the layered composite.

The invention relates to a decorative laminate, in particular a structured decorative laminate, comprising a substrate-side decorative layer which, in addition to other applications, is particularly advantageously used as a floor covering, wall panelling or furniture film. The invention also relates to such floor coverings, wall panelling or furniture films and to a method for manufacturing the decorative laminates in accordance with the invention.

Favourable manufacturing and material costs, ease of processing, chemical stability, high transparency, good wear resistance and high elasticity have in the past made polyvinyl chloride (PVC) the dominant synthetic base material for floor coverings, wall panelling and furniture films.

PVC films have for example found various applications in the manufacture of cheap furniture surfaces, wall panelling or floor coverings which imitate wood or stone surfaces, partly using wood and partly using layers of paper or film with a wood or stone design printed on them.

The advantages are countered by disadvantages such as the negative health and environmental impact of PVC and its properties when burned, which have spurred on the search for alternative materials as a substitute for PVC.

Many polymers such as polyolefins, polyamides, polyurethanes, polystyrene, polyesters and their copolymers and derivatives have been proposed as substitute materials; they are similarly cheap and easy to process, but have been inferior to PVC in terms of their mechanical properties and wear resistance. The visible sides of conventional floor coverings, wall panelling, furniture films and similar composites are often reinforced using layers of varnish or resin, for example melamine resin. This increases the cost of the composite films due to the higher raw material costs and processing costs and downgrades their life cycle assessment. Composite materials have also already been described which attempt to combine the advantages of cheap polyolefins as a substrate material with the superior mechanical properties of polar polymers. To date, these efforts encounter difficulties in ensuring a secure and durable interconnection between the layers, if possible without using adhesive or solvent, providing an efficient and continuous method for manufacturing the composite, and embodying the manufacturing method such that the appearance of the multi-layered film meets the highest aesthetic demands and can serve as a substitute for natural materials such as for example wood surfaces, stone surfaces or cork surfaces. WO 95/08593 A1 describes, as an alternative to PVC floor coverings, wear-resistant floor coverings which comprises a transparent covering layer made of ionomer, laminated onto a decorative layer via a layer of adhesive. DE 41 07 150 A1 describes a multi-layered floor covering film, wherein an upper film which contains plastic including polar groups is deposited onto a lower film via a bonding layer, bonding film, reactant layer or tie layer. DE 10 2012 103 016 A1 describes a film laminate composite comprising at least two plastic films, including a substrate film and a utility film, wherein the utility film is arranged on one side of the substrate film and can be printed on, the substrate film is a polyolefin film which is preferably pigmented, and the utility film consists of a thermoplastic polyurethane. These laminate composites are explicitly manufactured by adhesive lamination or heat lamination, avoiding decorative paper, and are recommended for use in the floor industry, furniture industry, interiors industry and/or exteriors industry. Embossments and associated problems are not mentioned in these documents.

Conventionally, embossments are made on the visible side of generic films, for example in order to imitate the surface of the natural materials mentioned, in a discontinuous process by hot-embossing or embossing the cooled films after they have been laminated onto a decorative layer which is printed on, or discontinuously or continuously before they are connected to the decorative layer, wherein a visible-side polymer layer, once it has been profile-extruded, is cooled down to about 140° C., spread with adhesive and provided with a rear-side decorative layer. The embossing pattern is then embossed on. This method has the disadvantage on the one hand that a relaxation of the embossed plastic leaves the embossing depth on the visible side significantly lower than is predetermined by the embossing die and that the embossed image is adversely affected by trapped air, while on the other hand, the substrate side the side facing away from the visible side is perforated. This makes it more difficult to apply adhesive on the substrate side and/or increases the amount of adhesive needed to establish a satisfactory connection to the substrate. Another problem is the low thermal resistance of conventionally embossed profiles.

WO 2012/001109 A1 describes a method for manufacturing floor elements in which a decorative layer is initially applied to a polymeric composite layer, generally a wood-plastic composite (WPC) layer, without adhesive by means of hot-melt laminating, and the decorative layer, once printed on, is successively coated with a tie layer and an ionomer layer, as applicable, wherein the method can be rounded off with a subsequent embossment. In accordance with WO 2012/001109 A1, it is alternatively also possible to prefabricate a layered composite consisting of an ionomer layer and a polymer layer and to continuously or discontinuously emboss it as it is laminated onto a substrate such as WPC. These methods also raise questions about the optimum ratio of embossment and perforation and about continuously conducting the method in a way which is economical and avoids a second or subsequent heating cycles and is suitable for providing multi-layered composite films which can be universally employed.

Coverings, for example floor coverings, which exhibit increased wear resistance are also desirable. For office floor coverings and industrial or commercial applications, a hard-wearing covering is required which minimises the problem of burnishing on a surface which is originally intended to be matt. Such burnishing often occurs under mechanical stress, for example from chair castors. Wear resistances which a floor covering for commercial use or as a furniture film should be able to maintain are specified in accordance with the wear test according to DIN 13329:2013-12.

The problem of providing a decorative laminate which exhibits very good bonding between the respective layers and contains substantially no harmful substances, in particular no vinyl chloride monomers, and only requires a minimum of adhesive and solvent or ideally does not contain adhesive or solvent, and also exhibits excellent operational resistance has not yet been satisfactorily solved. Another object of the invention is to additionally minimise the problem of perforation in the manufacture of structured decorative laminates.

The particular demands made on floor coverings include protection against electrostatic charge. Maintaining the standard for walking voltage according to DIN EN 1815:2016-12 ensures that unpleasant discharges via the skin can be avoided or an absence of dust ensured. Particular standards in anti-static efficacy are a prerequisite for floors in rooms for producing electronic components. Statically charged decorative films can also cause problems in the manufacture of for example floor covering laminates. In order to have an effect, anti-static agents are conventionally provided in the uppermost polymeric thermoplastic layer on the visible side of floor covering laminates and floor covering layered bodies. In order to protect against wear, such anti-static laminates are conventionally provided with a protective varnish, wherein varnishing represents an additional method step which incurs apparatus requirements and is undesirable in principle and which can cause additional costs and solvent emissions.

Another object of the invention is therefore to provide decorative laminates which are wear-resistant and/or permanently anti-static, if possible in accordance with standards, and do not require a varnishing layer and can be manufactured continuously in a single method step.

The present invention solves at least one, preferably more than one up to all of the problems mentioned and combines, for the first time, the aesthetic advantages of natural materials, the ecological and non-toxicity advantages of PVC-substitute polymers, and the economic, processing and mechanical advantages of PVC films. In accordance with the invention, the object is solved by a decorative laminate, in particular a structured decorative laminate, comprising at least the following immediately consecutive and mutually bonded layers A-B-C-D:

A: on the visible side, a functional layer comprising one or more ionomers and optionally one or more filler materials and/or functional additives dispersed in the layer;

B: an intermediate polymer layer comprising a mixture consisting of 5 to 95% by weight of extrudable ionomer, extrudable ionomer mixture or extrudable ionomer blend and 95 to 5% by weight of a polyolefin;

C: a tie layer comprising one or more modified plastics for the tie;

D: on the substrate side, a decorative layer;

characterised in that the layered composite consisting of the layers A, B and C is coextruded and hot-melt laminated with the substrate-side decorative layer at a temperature above the fusion temperature of the layered composite.

Ideally, one or more patterns is then plastically embossed on the visible side of the decorative laminate simultaneously in the same step, during hot-melt laminating, whereby a structured decorative laminate in accordance with the invention is obtained. This can in particular be ensured if the plastic (three-dimensional relief-like) pattern(s) is/are embossed using the same rollers as for hot-melt laminating. Simultaneously hot-melt laminating and embossing in the same step maximises energy efficiency for example, since an additional heating step is avoided and simultaneously a maximum impression, i.e. a maximum impression ratio of the achieved surface roughness R_{Z} to the surface roughness R_{Z} of the embossing roller, is achieved. Impression ratios of greater than 75%, in particular greater than 80% and preferably greater than 90% or even greater than 95% up to at least 97% can for example be achieved in accordance with the invention.

The polymer portion of the functional layer A can consist of an ionomer or can comprise a mixture consisting of two or more ionomers or an ionomer blend. In one embodiment, the functional layer A consists substantially of an ionomer. In a preferred embodiment, the polymer portion of the functional layer is in the range of 75 to 99% by weight, in particular 80 to 98% by weight, more preferably 90 to 97% by weight and most preferably 94 to 96% by weight. The proportion of filler materials and functional additives in the functional layer is thus generally between 0 and 25% by weight and preferably in the range of 1 to 25% by weight, in particular 2 to 20% by weight, more preferably 3 to 10% by weight and most preferably 4 to 6% by weight.

The ionomers for the functional layer A can advantageously be selected, independently of each other, from the same polymers as for the intermediate polymer layer B. Ionomer blends, for example blends of ionomer(s) with polyamide(s), or ionomers which exhibit a density (DIN EN ISO 1183-1:2013-04) in the range of 0.8 to 1.2 g/cm³, in particular 0.9 to 1.0 g/cm³ and most particularly about 0.94 to 0.96 g/cm³, are particularly advantageous for use in the functional layer A and in the intermediate layer B. Ionomers which a melt flow index (MFI) at 190° C. and 2.16 kg in accordance with (DIN EN ISO 1183-1:2013-04) in the range of 0.4 to 7.0 g/10 min, in particular 0.5 to 5.7 g/10 min, most particularly advantageously 0.6 to 0.9 g/10 min or also 5.3 to 5.6 g/10 min, are preferred. The melting point (DIN EN ISO 3146:2002-06) of the ionomer used is advantageously in the range of 85 to 98° C., in particular 88 to 97° C. and most particularly advantageously 89 to 92° C., or also 94 to 96° C. The vicat softening point (DIN EN ISO 306:2012-01) of the ionomer used is advantageously in the range of 60 to 70° C., in particular 62 to 68° C. and most particularly advantageously around 65° C. A Surlyn ionomer or a mixture consisting of Surlyn ionomers is for example used in accordance with the invention. It is advantageous if the polymer or polymer mixture is transparent or semi-transparent. For the purposes of the invention, the decorative pattern of the decorative layer D is preferably visible through the layers A, B and C.

The ionomers, ionomer mixtures and ionomer blends used can be partly or completely from each other in the layers A and B or can differ only in their respective proportions. In a particularly preferred embodiment, however, the same ionomer, ionomer mixture or ionomer blend is used for the functional layer A as is used in the intermediate layer B. In this case, the adhesion of the layers A and B is at its highest, which has an advantageous effect on their resistance to peeling. The respective ionomers used are particularly advantageously identical.

The filler materials of the functional layer A mentioned can advantageously be selected in accordance with the invention from the group consisting of corundum, titanium oxide, sand, talc, chalk, silica, glass beads and mixtures of the same. Functional additives which can be a constituent of the functional layer A include UV stabilisers, UV absorbers, colour pigments, waxes, lubricants, anti-slip additives, anti-static agents, anti-microbial and dehesively acting additives and flame retardants and mixtures of the same. In a particularly preferred embodiment, the functional additives of the functional layer comprise one or more anti-static agents, in particular in an amount of between 0 and 25% by weight, preferably in the range of 1 to 25% by weight, in particular 2 to 20% by weight, more preferably 3 to 10% by weight and most preferably 4 to 6% by weight.

Migratory and non-migratory (permanent) anti-static agents can in principle be used in accordance with the invention. Non-migratory anti-static agents are however preferred. Anti-static agents which can accumulate at the surface of the layer by migration due to their small molecular size are referred to as migratory anti-static agents. Water molecules can be absorbed from the air by these surface-active substances, thus forming a conductive surface film via which charges can be uniformly distributed and dissipated. Examples of migratory anti-static agents which may be cited include: GMS (glycerol monostearate), alkyl sulphonates and ethoxylated alkyl amines. Anti-static agents which form a conductive network within the plastic matrix are referred to as non-migratory anti-static agents. Examples of non-migratory anti-static agents which may be cited include: graphite, soot, metals or intrinsically conductive polymers.

If the functional layer A contains anti-static agents, the functional layer A preferably does not contain any other functional additives, in particular filler materials.

The particle size of the filler material particles dispersed in the functional layer A is typically at least 90%, preferably at least 95%, in the range of 0.5 to 100 μm, preferably 2 to 10 μm. The shape of the dispersed particles is non-critical. Ideally, the particles will be present in a spherical shape, wherein the particle size of the dispersed filler material particles can preferably exhibit a median D₅₀ of up to 10 μm, preferably 2 to 6 μm and particularly preferably 3 to 5 μm.

The intermediate polymer layer B comprises a mixture consisting of 5 to 95% by weight, in particular 50 to 94% by weight, most particularly 70 to 92% by weight and particularly preferably 80 to 90% by weight, for example 85% by weight, of extrudable ionomer, extrudable ionomer mixture or extrudable ionomer blend. The intermediate polymer layer B additionally comprises 95 to 5% by weight, in particular 50 to 6% by weight, most particularly 30 to 18% by weight and particularly preferably 20 to 10% by weight, for example 15% by weight, of a polyolefin. The intermediate polymer layer B can as applicable contain up to 10% by weight of one or more other polymeric materials, filler additives, effect additives and/or functional additives, providing the sum does not exceed 100% by weight.

Metallocene polyolefins, such as polypropylene, are in particular preferred polyolefins, and metallocene polyethylene is most preferred.

Due to the plastics used, the layered structure in accordance with the invention and the method in accordance with the invention, it is possible to completely or largely omit the presence of plasticisers in the plastics. The presence of any carcinogenic residual monomers, such as occur for example in PVC, is likewise omitted. The high wear resistances, flexibility, simplicity and economy in the manufacture, optics and haptics of the product, as mentioned at the beginning, are nonetheless achieved, such that the present invention represents an at least equivalent substitute for PVC films, without exhibiting the associated disadvantages.

The tie layer C comprises one or more modified plastics for the tie. Advantageously, in accordance with the invention, the modified plastic(s) for the tie can preferably comprise one or more polymer(s) modified with maleic anhydride, alkylated maleic anhydride and/or carboxylic acid. The modified plastic(s) for the tie can advantageously comprise one or more copolymer(s) or grafted (co)polymers of monomers which support carboxylic acid functionality, in particular maleic anhydride and/or alkylated maleic anhydride with polypropylene, polyethylene (for example LDPE or LLDPE), ethyl-vinyl acetate (EVA), ethylene-butyl acrylate (EBA), ethylene-ethyl acrylate (EEA), ethylene-acrylic acid (EAA), ethylene-methacrylic acid (EMAA), maleic acid acetate (MAA) and/or polyacrylate rubber (ACM).

The tie layer C can then represent a homogenous layer. Alternatively, it can comprise several, for example two, three or more layers which respectively contain the same or different members of the aforementioned modified plastics for the tie. In some embodiments, improved bonding between the layers B and D is achieved by a succession of different modified plastics for the tie.

The layered composite consisting of the layers A, B and C and, as applicable, additional layers adjoining the layer A is coextruded at temperatures at which the polymers are fused. It is preferably coextruded at temperatures in the range of 100 to 400° C., particularly preferably in the range of 200 to 300° C. The following step of embossing and hot-melt laminating is performed as long as the coextruded layered composite is above the fusion temperature. Embossing and hot-melt laminating can typically be performed at temperatures above 200° C., in particular above 230° C., for example at at least 250° C., but advantageously below 280° C. or 260° C. Hot-melt laminating is advantageously performed in the same machine, temporally and spatially immediately following coextrusion.

Due to coextrusion, one or more additional laminating steps and the associated additional apparatus requirements and the use of adhesives and solvents is avoided. In addition to the improved procedural economy and reduced emissions from solvent pollution, coextrusion also enables particularly firm bonding between the respective layers. It is assumed that this is also due to increased interpenetration between neighbouring layers in the extrusion process.

One advantage of the invention is that the layered composite ABCD can be made largely without any solvent and/or adhesive. Ideally, the composite does not contain any organic solvents and/or adhesives.

Because embossing and hot-melt laminating are simultaneous, a realistic embossing depth can be achieved on the visible side of the multi-layered composite film, while the problem of “perforating” onto the substrate side can be avoided completely or to the greatest possible extent. Since the coextruded layered composite A-B-C has not yet cooled and the embossment is to all intents and purposes made in the molten mass, there is no perceptible or only minimal relaxation after embossing. In accordance with the invention, it is surprisingly possible to avoid “perforation” to the greatest possible extent and to simultaneously achieve a high degree of wear resistance and low staining.

Another advantage is that embossing is more temperature-resistant and that the embossed multi-layered film can be simultaneously thermoformed without destroying the embossment. This is in particular highly significant for applications as a 3D film, for example as a furniture film or as a decorative film for doors. Without being bound by theory, the inventors attribute this to the fact that embossing is performed plastically and with a minimal elastic portion or no elastic portion.

The method is also highly economical, since an additional heating cycle for laminating is not required. The method in accordance with the invention also enables a reliable connection between the substrate, the decorative layer, the intermediate polymer layer and the visible-side polymer layer containing thermoplastic ionomer. Conventionally laminating the soft material of the visible-side polymer layers with the decorative layer, by contrast, involves disadvantages such as for example the need to apply adhesive, the use of solvents, poorer bonding and additional method steps.

The dimensionless embossing depth index Ip represents one measure of the “perforation” achieved using a selected embossing roller (pattern, surface roughness R_{Z} of the die engraving). It is calculated from the ratio of the embossing depth on the visible side to the perforation on the substrate side, each measured as an average surface roughness R_{Z} (DIN EN ISO 4287:2010-07), divided by the thickness of the structured decorative laminate, multiplied by 1000, all values being in micrometres:

I_{P}=R_{Z}(visible side)×1000/(R_{Z}(substrate side)×thickness(decorative laminate)).

If the decorative laminate corresponds to the layered composite A-B-C-D, then:

I_{P}=R_{Z}(visible side)×1000/(R_{Z}(substrate side)×thickness(A-B-C-D)).

An embossing depth index of at least 7.0 after cooling is preferably achieved in accordance with the invention. For some applications, an embossing depth index of at least 8.0 or at least 9.5 or 10 to 20, preferably at least 13 or even more advantageously at least 14 or at least 16 can be achieved. Embossing depth indices of up to 30 or higher, for example 7.0 to 30, 8.0 to 30, 6.0 to 20, 9.5 to 30, 9.5 to 20, 10 to 30 or particularly preferably 13 or 16 to 30, can be achieved in accordance with the invention.

The difference between decorative films embossed in accordance with the invention and conventionally embossed decorative films becomes even clearer if the embossing depth index I_{P} mentioned is multiplied by the respective impression ratio, thus additionally taking into account the fidelity to the original of the plastic embossed image. The corresponding value I_{P}*R_{Z} (film)/R_{Z} (roller) is referred to in the following as the “modified embossing depth index”.

One advantage of a large embossing depth index and/or modified embossing depth index is that the visible side can be embodied to be warm, soft, impact sound-absorbing and plastic and for example to realistically imitate the tactile sensation and optical/aesthetic impression of coarse wood, coarse natural stone or leather, while the surface of the layer on the substrate side can be kept as smooth and even as possible. This facilitates connecting it to a substrate E. The amount of adhesive required to connect it to a substrate E is for example minimised. The present invention additionally provides, for the first time, structural films which have no layer(s) of varnish or resin for additional visible-side protection but are nonetheless suitable for meeting the demands of wear resistance, chemical stability, scratch resistance, low staining, high durability and good resilience. The multi-layered composite film in accordance with the invention advantageously contains no PVC and/or melamine resin.

In accordance with the invention, one embodiment of the decorative layer can comprise paper and/or plastic film which is printed on, wherein the plastic film can be monoaxially or biaxially orientated. In one preferred embodiment, the decorative layer comprises paper which is impregnated with plastic or embedded in plastic. In another preferred embodiment, the decorative layer contains no paper. Printing on film can be particularly preferable in accordance with the invention due to the increased brilliance. Casein-based printing inks (casein inks) and/or polyurethane-based inks are particularly preferred in accordance with the invention. The decorative pattern can be colourless, white, plain-coloured or coloured in some other way. The colour of the decorative pattern preferably draws on the natural colour of the imitated surface, for example wood, natural stone or leather.

In one embodiment, the decorative layer D comprises a primer.

In some cases, it can be expedient to apply a primer to the decorative layer, for example via a calender. This can improve the interconnection with the layered composite A-B-C, for example when casein printing inks are preferably used. The invention similarly relates to layered composites in accordance with the invention in which substrate-side decorative layer does not comprise a primer.

The patterns embossed on in accordance with the invention are in principle unrestricted in terms of their embossing depth and design, although the maximum embossing depth is predetermined by the thickness of the layer, wherein the designs can be imitations of natural materials such as wood, stone, leather, textiles, a stucco structure or any pattern which can be represented on a continuous roller, wherein the high degree of impression achieved by the method in accordance with the invention enables as great a match and reproduction accuracy as possible between the embossed surface and the natural original. In accordance with the invention, the pattern embossed on can particularly advantageously be synchronised with the printed pattern, such that for example in the case of wood imitation, the tactile sensation of the texture matches the optical impression. Embodying the respective pattern as a continuous and uninterrupted repetition further reinforces the true-to-nature impression. In a preferred embodiment of the invention, the profile or pattern embossed on is therefore synchronised with the decorative pattern.

In one embodiment of the invention, the decorative layer D contains an extrudable thermoplastic polymer selected from the group consisting of polyethylenes, polypropylenes and polybutylenes, polystyrene, polyamide, polyester such as polyethylene terephthalate (PET) and mixtures of the same. One advantage of such decorative layers containing plastic film is their good printability, good process capability, their water resistance and their chemical stability.

The functional layer A typically, though not necessarily, exhibits a thickness in the range of 1 to 200 μm, preferably 5 to 100 μm, in particular 20 to 80 μm and particularly preferably 40 to 60 μm. The intermediate polymer layer B typically, though not necessarily, exhibits a thickness in the range of 10 to 500 μm, preferably 40 to 300 μm, in particular 100 to 280 μm and particularly preferably 200 to 250 μm. The tie layer C typically, though not necessarily, exhibits a thickness in the range of 1 to 100 μm, preferably 5 to 30 μm, in particular 10 to 25 μm and particularly preferably about 20 μm. The substrate-side decorative layer D typically, though not necessarily, exhibits a thickness of 10 to 500 μm, preferably 50 to 150 μm, in particular 100 to 140 μm, for example about 120 μm. All of the layer thicknesses given refer to arithmetical means in embossed regions and/or to layer thicknesses with no embossment.

The intermediate layer B is preferably thicker, in particular by at least 50 μm, particularly preferably at least 100 μm or most particularly preferably at least 150 μm or at least 200 μm, than the functional layer A.

The decorative laminate of the present invention can also advantageously be embodied such that it comprises at least the consecutive and mutually bonded layers F-A-B-C-D, wherein the layer F denotes one or more mutually bonded layers. The layer F can be connected to the layer A directly, via a bonding layer or adhesive layer, by lamination or by mechanical connecting elements. The layer F, or two or more layers which are subsumed here as “F”, is/are advantageously connected to the layers A, B and C by coextrusion in the same processing step, wherein the layer or layers F can for example have a total thickness of 1 to 200 μm, advantageously 10 to 100 μm. Each individual layer F can advantageously exhibit a thickness of 1 to 40 μm, most preferably 10 to 20 μm. The dimensionless embossing depth index I_{P} is defined, in this case of an additional layer F, as follows (all values in μm):

I_{P}=R_{Z}(visible side)×1000/(R_{Z}(substrate side)×thickness(F-A-B-C-D))

and measures at least 7.0. An embossing depth index of at least 8.0 or at least 9.5 or 10 to 20, preferably at least 13 or even more advantageously at least 14 or at least 16 can be achieved for some applications. Embossing depth indices of up to 30 or more, for example 6.0 to 30, 8.0 to 30, 6.0 to 20, 9.5 to 30, 9.5 to 20, 10 to 30 or particularly preferably 13 or 16 to 30, can be achieved in accordance with the invention.

The layer F can then advantageously comprise one or more of the following layers: one or more additional ionomer layers, a covering layer, a UV protection layer, a layer of varnish, an anti-staining layer, a moisture protection layer, a mechanical protection layer, an anti-static layer, a layer which prevents slipping, or a (heat-melt) adhesive layer, wherein each of the layers F can exhibit one or more of the functions mentioned and comprise corresponding functional additives. The layer or layers F can be transparent and/or can comprise a surface profile. At least one layer F containing ionomer, which preferably contains 60 to 100% by weight of ionomer as well as filler materials as applicable, is particularly preferred in accordance with the invention. The layer F can in particular contain 80 to 98% by weight or 90 to 95% by weight, most particularly preferably however at least 97% by weight of ionomer, as well as filler materials as applicable. 100% by weight of ionomer can be ideal.

The ionomers for a layer F can advantageously be selected, independently of each other, from the same polymers as for the functional layer A and the intermediate polymer layer B. Ionomer blends, for example blends of ionomer(s) with polyamide(s), or ionomers which exhibit a density (DIN EN ISO 1183-1:2013-04) in the range of 0.8 to 1.2 g/cm³, in particular 0.9 to 1.0 g/cm³ and most particularly about 0.94 to 0.96 g/cm³, are particularly advantageous for use in a layer. Ionomers which a melt flow index (MFI) at 190° C. and 2.16 kg in accordance with (DIN EN ISO 1183-1:2013-04) in the range of 0.4 to 7.0 g/10 min, in particular 0.5 to 5.7 g/10 min, most particularly advantageously 0.6 to 0.9 g/10 min or also 5.3 to 5.6 g/10 min, are preferred. The melting point (DIN EN ISO 3146:2002-06) of the ionomer used is advantageously in the range of 85 to 98° C., in particular 88 to 97° C. and most particularly advantageously 89 to 92° C., or also 94 to 96° C. The vicat softening point (DIN EN ISO 306:2012-01) of the ionomer used is advantageously in the range of 60 to 70° C., in particular 62 to 68° C. and most particularly advantageously around 65° C. A Surlyn ionomer or a mixture consisting of Surlyn ionomers is for example used in accordance with the invention. It is advantageous if the polymer or polymer mixture is transparent or semi-transparent. For the purposes of the invention, the decorative pattern of the decorative layer D is preferably visible through the layers F, A, B and C.

The ionomer(s) of a layer F can then be identical or different to one or more ionomers of the layers A and/or B. Preferably, all or some of the ionomers used in the respectively adjoining layers F and A and/or A and B, and in particular in the layers F, A and B, are identical.

In a particularly preferred embodiment of the invention, the decorative laminate comprises at least the consecutive and mutually bonded layers F-A-B-C-D, wherein the layer F denotes one or more mutually bonded layers and contains 60 to 100% by weight of thermoplastic extrudable ionomer, as well as filler materials as applicable, and wherein the functional layer A contains 5 to 40% by weight of one or more non-migratory anti-static agents. The functional layer A preferably consists of the ionomer or ionomer mixture and one or more anti-static agents, in particular one or more non-migratory anti-static agents. The decorative laminate of this embodiment preferably does not comprise a layer of varnish.

For while a desired anti-static function is conventionally achieved by using anti-static agents in the outermost visible-side thermoplastic layer, anti-static agents are used in accordance with the invention in the functional layer A, under an overlying ionomer layer F which contains thermoplastic ionomers or which is purely thermoplastic and does not contain anti-static agents. The layer thickness of the visible-side layer F is preferably in the range of 10 to 100 μm, in particular 20 to 80 μm or even more preferably 30 to 50 μm. The susceptibility to wear of conventional anti-static decorative laminates, which without a protective additional layer of varnish quickly lose their anti-static effect during use, can thus be surprisingly overcome in accordance with the invention even without using a layer of varnish, and without having to compromise on the efficacy of the anti-static effect and/or anti-staining properties or wear resistance. It is therefore preferable in accordance with the invention for the additional layer F to be the uppermost visible-side layer and to not contain a layer of varnish or a coating consisting of curable and/or cross-linkable or cross-linked monomers and most particularly preferably to consist of a single thermoplastic ionomer layer which contains 1 to 10% by weight of filler materials as applicable.

Omitting in particular anti-static agents in the uppermost visible-side layer F also ensures that the micro-surface structure of the ionomer remains as dense and regular as possible and that optimum anti-staining properties can still be achieved even under mechanical stress.

In a most particularly preferred embodiment of the invention, the decorative laminate has a layered structure F-A-B-C-D, wherein: the functional layer A contains, in addition to the ionomer or ionomer mixture, non-migratory (permanent) anti-static agents, in particular in an amount of 10 to 30% by weight; and the additional layer F is the uppermost layer on the visible side and contains 90% by weight to 100% by weight of one or more ionomers and as applicable up to 10% by weight of filler materials, in particular 95 to 100% by weight of one or more ionomers and as applicable 3 to 5% by weight of filler materials. The most preferred anti-static agents include polyesters and polyamides or thermoplastic copolyamides such as for example polyether amide. As has already been stated above, the decorative laminate in accordance with the invention preferably does not contain a varnish or coating. In this way, it is possible to ensure that the layers F and A and also the layers B and C are completely or almost completely transparent and colour-neutral and thus do not block or cloud the view onto the decorative layer. This is for example not the case when using conventional permanent anti-static agents such as graphite, anthracite, metal particles, soot, carbon blacks, conductive nanoparticles or also conductive fibres, for example carbon fibres or meshes or composites of the same. Choosing the mutually compatible, immediately consecutive layers F-A-B-C also enables coextrusion in accordance with the method in accordance with the invention and optimum bonding with minimal use of ties and without using adhesives (and the associated disadvantages). It is also possible in accordance with the invention to refrain from providing the decorative layer D with additives having an anti-static effect. This enables a higher printing and image quality to be achieved, and any disadvantages which may occur in the bonding between the decorative layer and the adjoining layers C or E are avoided.

The decorative laminate in accordance with the present invention can for example and ideally be used as a floor covering or in the manufacture of a floor covering, as wall panels or roof panels or in the manufacture of wall panels or roof panels, as a furniture film, door film, 3D film, in particular in the manufacture of plywood board or chipboard and/or as a graphic film, in particular a printed film.

The invention also therefore relates to a floor covering, wall panels and roof panels, a furniture film, door film, 3D film, plywood and chipboard and graphic film, in particular printed film, comprising a decorative laminate in accordance with the invention. Layered bodies in accordance with the present invention, comprising a decorative laminate in accordance with the invention, in particular a structured decorative laminate, include in particular a floor covering, furniture film or 3D film.

A floor covering in accordance with the invention advantageously then comprises another layer E which is a substrate layer which adjoins the layer D and is connected to the layer D directly, via a bonding layer or adhesive layer, by lamination or by mechanical connecting elements. Within the framework of the present disclosure, the substrate layer E is not regarded as a constituent of the decorative laminate.

The substrate layer E preferably then comprises one of the following layers: a layer which prevents slipping, a heat-insulating layer, a sound-absorbing and in particular impact sound-absorbing layer, a heat-conducting layer, an adhesive layer, a plywood layer or chipboard layer, a wood-plastic composite (WPC) layer and a fibre-reinforced concrete layer.

In accordance with the invention, the layers A, B, C, D, E and F can contain no functional additives, effect materials and/or pigments; alternatively or additionally, the layers B, C, D, E and F can also contain no filler materials. Conversely, in another embodiment of the invention, one or more of these layers for example the layers D and/or E or the layers D and/or in particular B comprise functional additives, filler materials, effect materials and/or pigments in an amount of 1 to 25% by weight, preferably 2 to 20% by weight or 3 to 10% by weight, each and independently of each other, wherein the overall proportion of functional additives, filler materials, effect materials and/or pigments to the polymeric material does not of course exceed 25% by weight, preferably 20% by weight, in particular 10% by weight of the respective layer. In one embodiment, the layered composite A-B-C-D or in particular the layer D contains no inorganic filler materials, effect materials and/or organic or inorganic pigments. In another embodiment, it is precisely the presence of such pigments or filler materials in one or more of the layers A-B-C-D, in particular in layer A, which can provide for particular effects.

As described above, the invention similarly relates to a method for manufacturing a decorative laminate in accordance with the invention, characterised in that the layered composite consisting of the layers A-B-C or, as applicable, F-A-B-C is coextruded in a first step and hot-melt laminated with the decorative substrate layer at a temperature above the fusion temperature of the layered composite in the second step. As described above, the layer F here can stand for one or more of the described additional layers F. Advantageously, one or more patterns is plastically embossed on the visible side of the decorative laminate, simultaneously in the same step, while it is hot-melt laminated, wherein the temperature of the layered composite does not drop below the fusion temperature of the layered composite A-B-C or, as applicable, F-A-B-C between the first and second method steps. In this way, a structured decorative laminate in accordance with the invention is obtained.

The second method step is then advantageously performed at a temperature of 150 to 300° C. As already stated, the method in accordance with the invention is preferably performed continuously. The embossment on the visible side is preferably synchronised with the decorative pattern printed on the decorative layer.

Coextrusion is then performed in a conventional way under conditions which will be familiar to the person skilled in the art. Particularly advantageous properties of the multi-layered composite films in accordance with the invention can be achieved by performing the method steps of hot-melt laminating and embossing, which are known in their own right, simultaneously and without an additional heating cycle, in a continuous operation, in a preferred embodiment of the invention.

FIG. 1 shows a cross-section of an embodiment of the decorative laminate of the invention which exhibits the layered structure A-B-C-D. In this example, the layers are composed of:

Layer A (50 μm) 93% by weight of Surlyn ionomer and 7% by weight of silica as a filler material;

Layer B (230 μm) 80% by weight of Surlyn ionomer and 20% by weight of metallocene polyethylene (metallocene PE);

Layer C (20 μm) maleic-anhydride-modified polyethylene as a modified plastic for the tie;

Layer D (300 μm) paper or plastic film which is printed on using casein ink and coated (10 μm) with primer.

FIG. 2 shows a cross-section of another embodiment of the decorative laminate, for example as a floor covering which exhibits the layered structure A-B-C-D-E. In this example, the layers are composed of:

Layer A (50 μm) 94% by weight of Surlyn ionomer and 6% by weight of silica as a filler material;

Layer B (230 μm) 87% by weight of Surlyn ionomer and 13% by weight of metallocene polyethylene;

Layer C (20 μm) maleic-anhydride-modified polyethylene as a modified plastic for the tie;

Layer D (300 μm) paper or plastic film which is printed on using casein ink and coated (10 μm) with primer; Layer E (2000 μm) WPC.

FIG. 3 shows a cross-section of another embodiment of the decorative laminate, for example as a furniture film which exhibits the layered structure F-A-B-C-D. In this example, the layers are composed of:

Layer F (50 μm) varnish;

Layer A (80 μm) 100% by weight of extrudable ionomer;

Layer B (150 μm) 91% by weight of the same ionomer as in layer A and 9% by weight of metallocene polyethylene;

Layer C (5 μm) maleic-anhydride-modified polyethylene as a modified plastic for the tie;

Layer D (100 μm) PET which is printed on using casein ink and coated (10 μm) with primer.

In one modification, BOPP (biaxially orientated polypropylene) was used instead of PET in layer D.

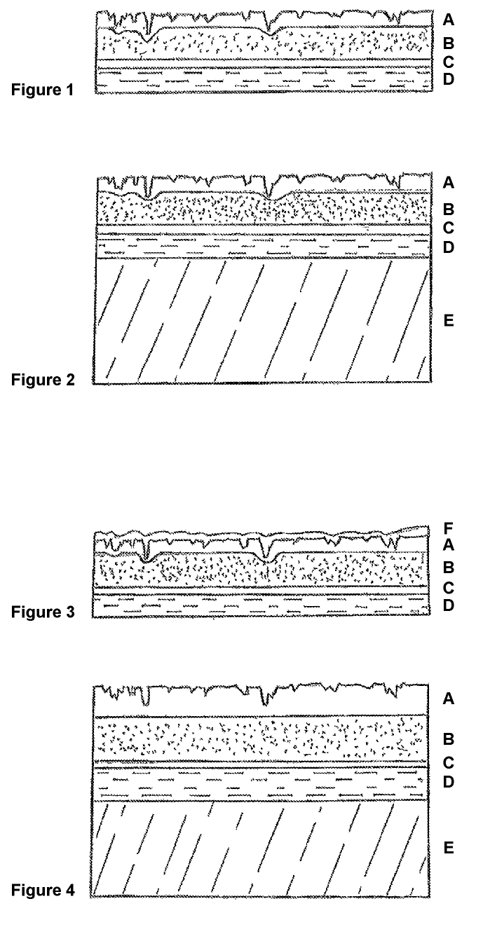

FIG. 4 shows a cross-section of another embodiment of the decorative laminate in accordance with the invention, for example as a furniture film which exhibits the layered structure A-B-C-D-E. In this example, the layers are composed of:

Layer A (80 μm) 100% by weight of Surlyn ionomer;

Layer B (120 μm) 95% by weight of the same Surlyn ionomer as in layer A and 5% by weight of metallocene polyethylene;

Layer C (10 μm) maleic-anhydride-modified polyethylene as a modified plastic for the tie;

Layer D (90 μm) paper which is printed on using casein ink and coated (10 μm) with primer;

Layer E (1500 μm) plywood layer, wood.

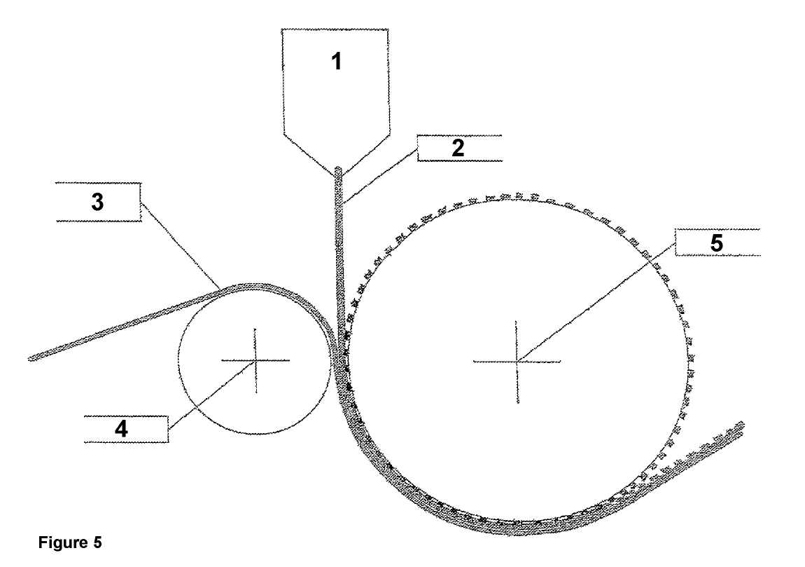

FIG. 5 shows a schematic and typical structure of the method in accordance with the invention, wherein a composite made of: a layer A, which consists for example of ionomer containing filler materials; a intermediate polymer layer B containing ionomer and polyethylene; and a (substrate-side) tie layer C as a molten mass 2; is coextruded in the nozzle 1 at a temperature of 200 to 280° C. and then immediately connected on the substrate side, at the same temperature, to a layer of paper D/3 which is printed on and which is fed via a roller 4, for example a rubber roller. The layer D and the layered composite A-B-C are hot-melt laminated and simultaneously embossed on the visible side in this embodiment between the embossing roller 5 and the roller 4 at temperatures in the range of for example 150 to 300° C. at the same time as they are converged or immediately after they have been converged.

### EXAMPLES

### Example 1

A structured decorative laminate exhibiting the following sequence of layers was manufactured according to the method in accordance with the invention, wherein the layers A, B and C were coextruded at 250° C. and then immediately hot-melt laminated with the polypropylene layer D (having a wood grain pattern printed on it in casein ink and provided with primer) while still at 230° C. and at a linear load of 14.5 kN/m (145 N/cm), wherein a plastic wood texture pattern (the surface roughness R_{Z} of the die engraving of the embossing roller was 120 μm) was embossed on the visible side, and a structured decorative laminate in accordance with the invention was thus obtained.

Layer A (50 μm) 95% by weight of ionomer (Surlyn® 1706 by Dupont), 5% by weight of silica having a particle size of 2 to 50 μm (95%);

Layer B (230 μm) 85% by weight of ionomer (Surlyn® 1706 by Dupont) and 15% by weight of metallocene polyethylene;

Layer C (20 μm) maleic-anhydride-modified polyethylene as a modified plastic for the tie;

Layer D (120 μm, including a maximum of 10 μm of primer) polypropylene film which is printed on using casein ink and coated with primer.

Table 1 lists some parameters for characterising the multi-layered composite film of Example 1 and Comparative Example 2.

In the examples, the thickness of the layers and/or of the decorative laminate or layered composite were set and monitored as an arithmetical mean via the throughput of the extruders in a way which is usual in the art.

### Comparative Example 2

A structured decorative laminate exhibiting the following sequence of layers was manufactured along the lines of Example 1. Unlike Example 1, the intermediate layer B did not contain polyolefin:

Layer A (50 μm) 95% by weight of ionomer (Surlyn® 1706 by Dupont), 5% by weight of silica having a particle size of 2 to 50 μm (95%);

Layer B (230 μm) 100% by weight of ionomer (Surlyn® 1706 by Dupont);

Layer C (20 μm) maleic-anhydride-modified polyethylene as a modified plastic for the tie;

Layer D (120 μm, including a maximum of 10 μm of primer) polypropylene film which is printed on using casein ink and coated with primer.

The layered composite films of Example 1 and Comparative Example 2 were laminated with chipboard/hot-melt adhesion and tested for scratch resistance (DIN 438-2), abrasion resistance, wear resistance (DIN EN 13329) and resistance to staining (DIN 438-2).

The wear value according to DIN 13329:2013-12 was measured using SH4, alternating after each 200 revolutions.

Table 1 compares Example 1 and Comparative Example 2

TABLE 1

| | | | Comparative | |
|---|---|---|---|---|
| | Example 1 | | Example 2 | |
| Overall thickness A-B-C-D | 420 | μm | 420 | μm |
| Embossing depth index I_{P} | 16.62 | | | |
| Density | 0.985 | g/cm³ | | |
| Grammage | 3.913 g/100 cm² | | | |
| Young's modulus, longitudinal | 360 | MPa | 472 | MPa |

| | | |
|---|---|---|
| Maximum elongation, longitudinal | 251% | 244% |
| Elongation at rupture, longitudinal | 251% | 244% |
| wear at a thickness of 420 μm | 3840 | 2400 |

(DIN EN ISO 527-3/1B/200) The average surface roughness R_{Z} was determined using the MAHR perthometer.

### Example 3

In Example 3, the same sequences of layers ABC as in Example 1 was coextruded at 250° C. and then immediately hot-melt laminated with the same polypropylene layer D (having a wood texture pattern printed on it in casein ink and provided with primer) while still at 230° C. and at a linear load of 14.5 kN/m (145 N/cm), using a smooth roller. The decorative laminate obtained was cooled to room temperature and reheated to 125° C. in a subsequent step, and a plastic wood grain pattern was embossed on it at this temperature using the same embossing roller as in Example 1 and at the same linear load, in order to obtain a structured decorative laminate.

The embossing depth index I_{P} was determined after cooling. To this end, the respective roughness of Example 1 which is hot-melt embossed in accordance with the invention and of Example 3 which is subsequently embossed is measured at five respectively matching points in the embossment. Even before it is held at an elevated temperature, significant differences in roughness and embossing depth index I_{P} were measurable (Table 2).

The structured decorative laminates were then placed in the furnace for 30 minutes at 135° C. and then assessed optically, and the embossing depth index was determined again. While the structure embossed on the hot-melt embossed sample (Example 1) was still visible, the embossment on the subsequently embossed sample was already no longer identifiable.

The roughness was again measured at five respectively matching points in the embossment in order to determine the embossing depth index I_{P} (Table 2).

The layered composite films were laminated with chipboard/hot-melt adhesion and tested. The layered composites in accordance with the invention exhibited good to very good results throughout, including in terms of scratch resistance (DIN 438-2), abrasion resistance and resistance to staining (DIN 438-2).

TABLE 2

| | Without being held at an elevated temperature | | | | After 30 minutes being held at an elevated temperature of 135° C. | | | |
|---|---|---|---|---|---|---|---|---|
| | visible side | substrate side | embossing | | visible side | substrate side | embossing | |
| | R_{Z} [μm] | R_{Z} [μm] | depth index I_{P} | Appearance | R_{Z} [μm] | R_{Z} [μm] | depth index I_{P} | Appearance |
| Example 1 | 96.93 | 13.88 | 16.62 | embossment | 47.52 | 8.35 | 13.55 | embossment |
| | | | | clear, | | | | clear, |
| | | | | faintly matt, | | | | matt gloss, |
| | | | | natural | | | | natural |
| | | | | appearance | | | | appearance |
| Example 3 | 80.96 | 29.88 | 6.45 | embossment | 5.88 | 6.83 | 2.05 | embossment |
| | | | | poor, | | | | no longer |
| | | | | faint spots of | | | | visible, |
| | | | | gloss | | | | gloss |

### Example 4

The surface roughness R_{Z} of decorative films which exhibit the layered structure of Examples 1 and 3, which were on the one hand hot-melt embossed in accordance with the invention along the lines of Example 1 or subsequently embossed using the same embossing rollers along the lines of Example 3, were correlated with the surface roughness R_{Z} of the embossing rollers used which exhibit a wood texture pattern (“wood”) or leather texture pattern (“leather”), respectively. Table 3 shows the impression ratios obtained. The value achieved for subsequent embossing was always less than 75%, while values of over 80% were achieved for hot-melt embossing.

TABLE 3

| | hot-melt embossed | | subsequently embossed | |
|---|---|---|---|---|
| | wood | leather | wood | leather |
| R_{Z} roller [μm] | 120 | 110 | 120 | 110 |
| R_{Z} Film [μm] | 96.93 | 106.66 | 80.96 | 80.18 |
| impression ratio | 81% | 97% | 67% | 73% |

1. A decorative laminate, comprising at least the following immediately consecutive and mutually bonded layers A-B-C-D:
A: on the visible side, a functional layer comprising one or more ionomers and optionally one or more filler materials and/or functional additives dispersed in the layer;
B: an intermediate polymer layer comprising a mixture consisting of 5 to 95% by weight of extrudable ionomer, extrudable ionomer mixture or extrudable ionomer blend and 95 to 5% by weight of a polyolefin;
C: a tie layer comprising one or more modified plastics for the tie;
D: on the substrate side, a decorative layer;
characterised in that the layered composite consisting of the layers A, B and C is coextruded and hot-melt laminated with the substrate-side decorative layer at a temperature above the fusion temperature of the layered composite.

2. The decorative laminate according to claim 1, characterised in that one or more patterns are plastically embossed on the visible side of the decorative laminate simultaneously in the same step, during hot-melt laminating.

3. The decorative laminate according to claim 1, characterised in that it contains no PVC and/or melamine resin.

4. The decorative laminate according to claim 1, characterised in that the functional layer layer A and the intermediate layer B comprise the same ionomer or ionomer mixture.

5. The decorative laminate according to claim 1, characterised in that the polyolefin of the intermediate polymer layer B is selected from polyethylene and polypropylene and mixtures of the same.

6. The decorative laminate according to claim 1, characterised in that the modified plastic(s) for the tie comprise(s) one or more polymer(s) modified with maleic anhydride, alkylated maleic anhydride and/or carboxylic acid, in particular one or more copolymer(s) or grafted (co)polymers of monomers which support carboxylic acid functionality, in particular maleic anhydride and/or alkylated maleic anhydride with polypropylene, polyethylene, ethyl-vinyl acetate (EVA), ethylene-butyl acrylate (EBA), ethylene-acrylic acid (EAA), ethylene-methacrylic acid (EMAA), maleic acid acetate (MAH) and/or polyacrylate rubber (ACM).

7. The decorative laminate according to claim 1, characterised in that the decorative layer D contains an extrudable thermoplastic polymer selected from the group consisting of polyethylenes, polypropylenes and polybutylenes, polystyrene, polyamide, polyester and mixtures of the same.

8. The decorative laminate according to claim 1, characterised in that it comprises at least the consecutive and mutually bonded layers F-A-B-C-D, wherein the layer F denotes one or more mutually bonded layers which contains 60 to 100% by weight of thermoplastic extrudable ionomer, as well as filler materials as applicable, and wherein the functional layer A contains 5 to 40% by weight of one or more non-migratory anti-static agents.

9. The decorative laminate according to claim 1, characterised in that the functional layer A exhibits a thickness in the range of 1 to 200 μm, preferably 5 to 100 μm; and/or
the intermediate polymer layer B exhibits a thickness in the range of 10 to 500 μm,
the tie layer C exhibits a thickness in the range of 1 to 100 μm,
the substrate-side decorative layer D exhibits a thickness of 10 to 500 μm; and/or the additional layer F exhibits a thickness of 1 to 200 μm

10. A method of covering a floor or manufacturing a floor covering wall panels, roof panels or furniture film, said method comprising a step of covering a floor or manufacturing a floor covering, wall panels, roof panels or a furniture film, with a decorative laminate in accordance with claim 1.

11. A layered body comprising a decorative laminate in accordance with claim 1, as a floor covering, furniture film or 3D film.

12. The floor covering according to claim 11, characterised in that it comprises at least one other layer E which is a substrate layer which adjoins the layer D and is connected to the layer D directly, via a bonding layer or adhesive layer, by lamination or by mechanical connecting elements.

13. A method for manufacturing a decorative laminate according to claim 1, characterised in that the layered composite consisting of at least the layers A, B and C, or F, A, B and C, is coextruded in a first step and hot-melt laminated with the decorative layer D at a temperature above the fusion temperature of the layered composite in the second step.

14. The method according to claim 13, characterised in that one or more patterns are plastically embossed on the visible side of the decorative laminate simultaneously in the same step, during hot-melt laminating, wherein the temperature of the layered composite does not drop below the fusion temperature of the layered composite A-B-C or F-A-B-C, respectively, between the first and second method steps.

15. The method according to claim 14, characterised in that the second method step is performed at a temperature of 150 to 300° C.

16. The decorative laminate according to claim 9, wherein the functional layer A exhibits a thickness in the range of 5 to 100 μm.

17. The decorative laminate according to claim 9, wherein the intermediate polymer layer B exhibits a thickness in the range of 40 to 300 μm.

18. The decorative laminate according to claim 9, wherein the tie layer C exhibits a thickness in the range of 5 to 30 μm.

19. The decorative laminate according to claim 9, wherein the substrate-side decorative layer D exhibits a thickness of 50 to 150 μm.

20. The decorative laminate according to claim 9, wherein the additional layer F exhibits a thickness of 10 to 100 μm.

21. The method of claim 10, wherein the manufacturing step is manufacture of plywood board or chipboard, a 3D film, or a printed film.

22. The floor covering according to claim 12, wherein the substrate layer E comprises one of the following layers: a layer which prevents slipping, a heat-insulating layer, a sound-absorbing layer, a heat-conducting layer, an adhesive layer, a plywood or chipboard layer, a wood-plastic composite layer and a fibre-reinforced concrete layer.
